(19) United States
(12) Patent Application Publication
(10) Pub. No.: US 2013/0235963 A1
(43) Pub. Date: Sep. 12, 2013

(54) Deuterium Reactor

(71) Applicant: Pharis Edward Williams, Sun City West, AZ (US)

(72) Inventor: Pharis Edward Williams, Sun City West, AZ (US)

(21) Appl. No.: 13/337,203

(22) Filed: Mar. 12, 2012

(51) Int. Cl. G21B 1/19; G21B 1/05

(52) U.S. Cl. CPC G21B 1/19; G21B 1/05
USPC 376/121

(57) ABSTRACT

The Deuterium Reactor is a fusion reactor whose design is based upon a non-singular electrostatic required by the quantization of electric charge. This potential allows for a significant reduction in the fusion barrier of deuterium nuclei when these nuclei are held in close proximity, as within a crystal, and preconditioned using a magnetic field. This manner of fusion barrier reduction produces direct fusion of two deuterium nuclei into a helium nucleus without attendant hazardous radiation of classical fusion reactors. The energy released in the deuterium reactor may be used in different ways for different applications and its use will result in a significant reduction in fossil fuel use, a significant reduction in radioactive waste by replacing fission reactors, and a significant impact upon the world economy.

### STATEMENT REGARDING FEDERALLY SPONSORED RESEARCH OR DEVELOPMENT

$25,000 was received in 2008 from NSWC, Indian Head Division, to design experiments, review reports, and analyze data. The experiments verified heating using powered/granulated fuel.

### BACKGROUND OF THE INVENTION

This invention pertains to the field of fusion reactors as an energy source. This invention addresses the problems that occur with fission reactors such as the associated radiation and necessary heavy shielding required because of the radiation. It also addresses the high temperatures needed in the design of current fusion research reactors. Further, this invention addresses the problem of the national dependence on fossil fuel by providing an alternative source of energy for power plants and engines that currently depend upon fossil fuels.

Current approaches to obtain energy through nuclear fusion involve methods of heating combinations of ¹H¹, ¹H² and/or ¹H³ to very high temperatures in order to overcome the high coulomb repulsive forces between the protons involved. These high temperatures require the use of electromagnetic field containment in order to prevent the melting of the containment vessel. These reactors have shown nuclear fusion, but not in a manner that would allow the design of a practical energy source.

The designs of the research fusion reactors were based upon the current standard model understanding of neutrons and nuclei. That is, in nuclei there are neutrons that interact with the protons using short range, attractive nuclear forces, but only the long range, repulsive coulomb forces between the protons provide the barrier to fusion. This interpretation is the only one currently being used by the scientific community for attempting to obtain fusion energy. In recent years, there has been a great deal of activity and debate concerning attempts to obtain energy at much lower temperatures under the general title of “Cold Fusion.” For the most part, Cold Fusion devices are designed and tested without the aid of an assisting fundamental theory predicting the desired phenomena. Neither the high, nor the low, temperature fusion research has resulted in a clear road to a practical energy source, despite the claims of both sides.

Weyl's Quantum Principle, of 1929^{1,2,3}, has been shown to produce the equations of quantum mechanics and the gauge field equations. In particular, the gauge field equations of interest are the electromagnetic field equations of Maxwell. The Maxwell equations have been used to obtain the singular, 1/r, electromagnetic potential currently used for the charged particles and are the potentials used to calculate the coulomb repulsion between two protons. However, a closer study of Weyl's quantum principle shows that this principle not only requires Maxwell's field equations, but it also requires that the charge on a particle must be quantized. Experimentally, this is known to hold without fail, yet this is the first theory that requires the quantization of charge from a theoretical necessity. The quantization of electromagnetic fields in Maxwell's equations produces a more general electrostatic potential than the currently used one. This more general potential is non-singular. That is, the potential has a maximum absolute value and approaches zero as the separations of particles are brought infinitely close together or taken infinitely far apart.

This non-singular potential changes the picture of a neutron and the nucleus, plus it provides a description for how nuclei interact. This new picture of a neutron is simply a proton in orbit around a virtually stationary electron. Therefore, a deuteron, which is a neutron plus a proton, may be described as two protons in orbit around the electron. See FIG. 1. Each deuteron has a magnetic moment whose spin axis is normal to the plane of the three particles and the axis of deuterons may be aligned end to end by the use of a magnetic field. Once this preconditioning has been done, if the deuterons are nudged together, the long range repulsive interaction between protons causes the protons of the approaching deuterons to stay as far from each other as far as possible. See FIG. 2. The protons, therefore, self align to establish the minimum threshold energy for fusion. On the other hand, the electrons repel other electrons though they may be attracted to protons. A very stable configuration may be obtained by the fusion of two deuterons. In this stable configuration the four protons are in orbit in a plane about an orbit spin axis while the two electrons are located on the spin axis equal distances above and below the plane of the protons orbit. See FIG. 3.

The forces of the interactions between all six particles of the two deuterons have been written down and studied. However, since they are transcendental equations, they have not yet been analytically integrated, but have been submitted to a computer spreadsheet solution to determine the numerical value of the fusion threshold for different methods of nudging the deuterons together.

### REFERENCES

1. Williams, P. E., “Mechanical Entropy and its Implications,” Entropy, Vol 3, 76-115, 30 June 2001. http://www.mdpi.org/entropy/list01.htm#new
2. Williams, P. E., 1980, “The Dynamic Theory: A New View of Space, Time, and Matter,” Los Alamos National Lab report LA-8370-MS, December, 1980.
3. Williams, P. E., THE DYNAMIC THEORY—A NEW VIEW OF SPACE-TIME-MATTER, Williams Research, ISBN 978-0-615-44711-7, March 2011.

### BRIEF SUMMARY OF THE INVENTION

This invention takes advantage of the non-singular electrostatic potential and the newly predicted interactions between the electrons and protons that make up a deuteron and provides the conditions that bring about a fusion between two deuterons to form a helium atom. The preferential fusion of two deuterium atoms into a helium atom is brought about by preconditioning the deuterons in space and in their alignment with respect to each other. See FIG. 2 This conditioning is obtained by placing the deuterons into a crystalline lattice to hold them near each other. The crystalline lattice is placed in a strong magnetic controlling field to magnetically align the spins of the deuterium nuclei thereby starting the reaction. The addition of the heat causes the deuterium nuclei to vibrate within the crystalline lattice and this provides their motion with respect to each other which increases the reaction rate.

### BRIEF DESCRIPTION OF THE SEVERAL VIEWS OF THE DRAWINGS

FIG. 1: This figure depicts the configuration of a deuteron nucleus consisting of two protons orbiting around an electron.

FIG. 2: Two deuterium nuclei being nudged together while a magnetic field aligns their spins causing the protons of one nucleus to orbit 90 degrees from the protons in the neighboring nucleus.

FIG. 3: Two aligned deuterium nuclei may fuse together into a helium nucleus with the four protons orbiting in a plane 90 degrees from the axis of two electrons.

FIG. 4: This figure shows how permanent magnets may be used to align the spins of the deuterium nuclei in the sample.

FIG. 5: Thermo-electric diodes and metal hydride crystal fuel cells may be stacked together so that heat generated from a single fuel sample may power several diodes.

FIG. 6: Integrated reactor design showing cooling channels and electrical connections.

### DETAILED DESCRIPTION OF THE INVENTION

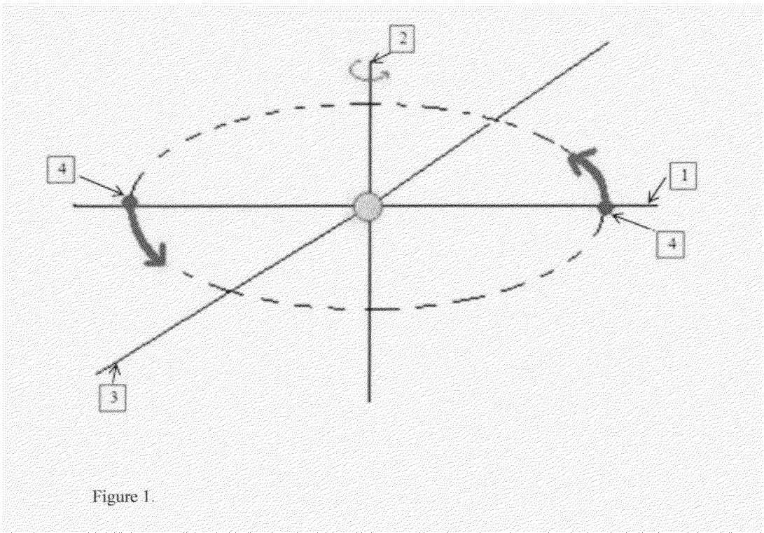

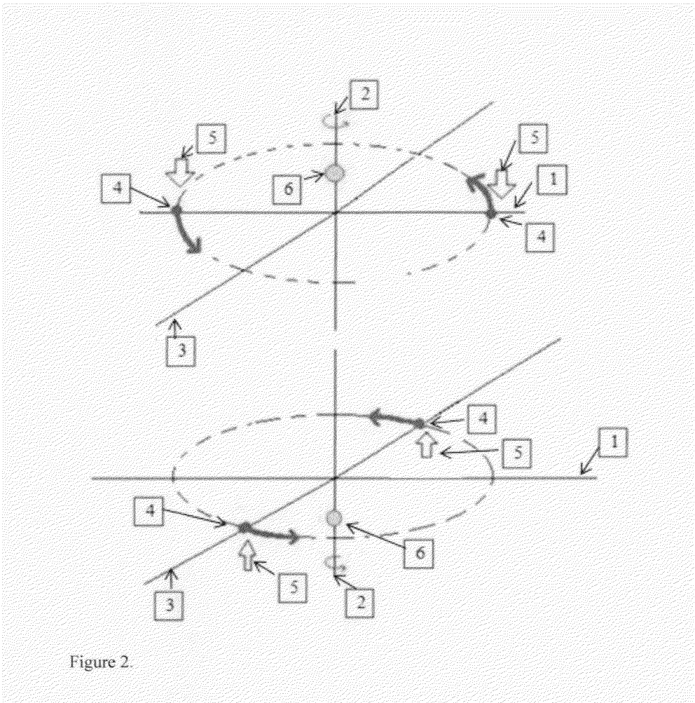

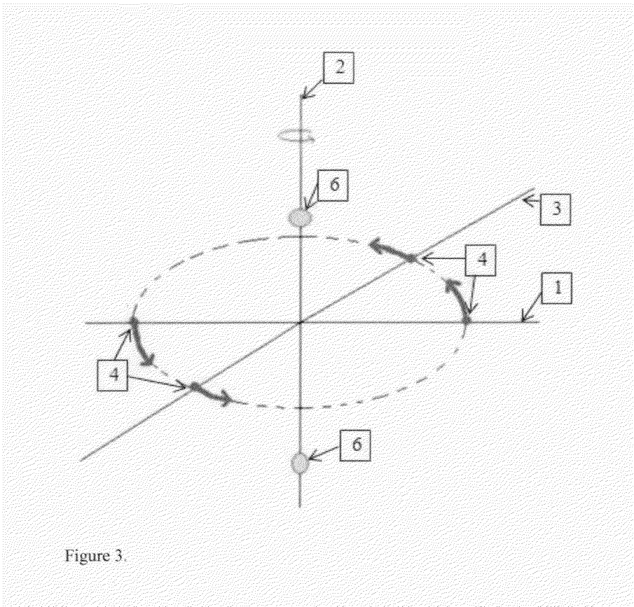

A crystalline hydride made with deuterium nuclei (FIG. 1), while in a magnetic field strong enough to align the atoms' spins in the same direction (FIG. 2), hold the atoms in the desired position for them to preferentially fuse and form a helium atom (FIG. 3). The rate of fusion depends upon quantum tunneling of the deuterons through the non-singular potentials of the nearby protons and the electron of the other deuterium nuclei. The rate of quantum tunneling, and therefore, the rate of fusion is controlled by the alignment of the deuterium nuclei and by either changing the separation of the two deuterons, their relative velocity, or both. The specific separation of the nuclei is set by the crystalline lattice spacing but their relative vibration velocity is determined by the temperature of the crystalline lattice. Therefore, while the magnetic field provides the alignment and the primary means of controlling the fusion rate, the temperature provides an additional means of controlling the rate of reaction and the rate of energy production.

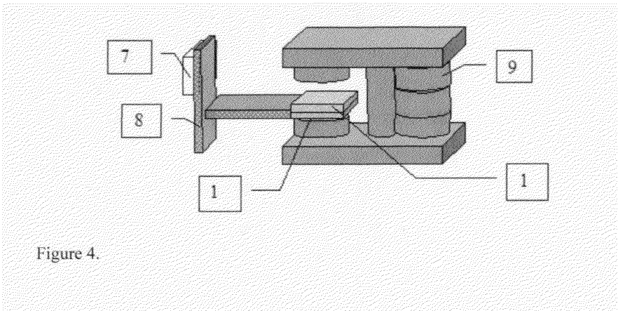

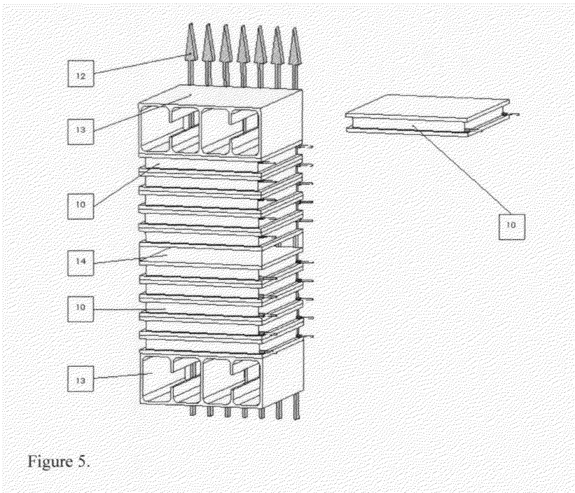

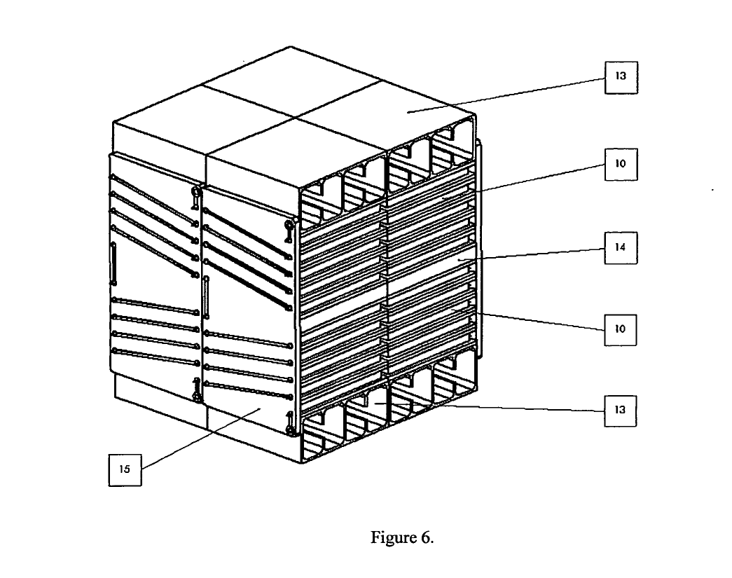

The operating temperature of a particular deuterium reactor will be established by type of heat removal, the spacing of the metallic lattice, and the desired energy production. The design of the reactor must include a means of carrying the energy away from the heat generation site, magnetic field control, and for temperature control. A low temperature method of carrying heat away is provided using thermal diodes which operate at temperatures less than 300 to 400 degrees centigrade (FIG. 4). Temperature control and a method of carrying away waste heat may be through the use of water flowing through channels in, or surrounding, the metallic hydride (FIGS. 5 and 6). The heat energy may be taken from the cooling water as in fission reactors where the operating temperature may be higher than thermal diode operating temperature.

Alternatively, the heat generated may be carried away from the reacting crystalline material directly without the use of the temperature limiting thermoelectric diodes. This may be done with a pressurized fluid so the temperature limit may be different from the 300 to 400 degree centigrade thermoelectric diode limitation. Once the heat is removed from the crystalline lattice containing the reacting deuterium nuclei it may used in any method needed. One such method may be the use of a secondary fluid to form steam. Or the heat carrying fluid may be used in a heat exchanger to heat another fluid such as asphalt.

### Desktop Reactor

A simple, desktop reactor design would include a sample of material placed upon a thermoelectric generating diode (TEG) and then placed in a magnetic field created by permanent magnets. A crude depiction of the reactor may be seen in FIG. 4.

The sample material should be sealed in a non-magnetic container that is flat, either round or square. It may be preferable, but not required, that the sample material be sealed in an inert gas such as argon if the fuel material is sensitive to moisture.

The thermoelectric generating diode (TEG) may be one such as supplied by Custom Thermoelectric of Bishopville, Md. (seehttp://customthermoelectric.com/tecs/pdf/12711-5L31-03CK_spec_sht.pdf) which produces 227 mV/° C. The voltmeter should have about 200 mV full scale so as to read roughly 1.8° F. at full scale. The holder should be designed to allow the low temperature side of the TEG to rest upon the lower magnet so the magnet may be used as a heat sink to maintain the temperature of the low side at a constant value.

The magnet stack may be made of 1″ diameter, 1″ high NdFeB, Grade N52 magnets such as supplied by K&J Magnetics, Inc. By using three magnets on the tall stack and one each above and below the sample the magnetic field should be of the order of 56 kilo gauss.

### Experimental Protocol

Let the sample rest outside the magnetic field for a period of time to see that the voltmeter reads zero as the two sides of the TEG are at the same temperature.

Place the sample and TEG into the magnetic field and observe the voltmeter for any voltage readings. One might expect between 0.5° F. to 1.0° F. in 10-20 minutes. This should show up as a reading of 60-130 mV on the voltmeter.

### Low Temperature Example of a Deuterium Reactor

### Rough Design of a Mobile Power Supply

Design assumptions

The assumptions that form the basis of this design outline are:
1. The experimental data obtained by the Navy on powdered fuel are taken as the starting point and converted into solid fuel heating rates,
2. The fusion energy is released as heat without any accompanying radiation just as the Navy experiments showed,
3. Reactor heat is converted into electrical energy by thermal diodes,
4. A cooling system provides a means of establishing an operating base and carrying away waste heat,
5. A bank of batteries allows for responding to rapid power demand changes while allowing a steady reactor output with slower power output changes,
6. One or more inverters will be used to convert DC energy into AC power,
7. Digital control circuitry will be used to control the magnetic field which is obtained using electrical circuits embedded into the reactor.

### Estimate of Solid Fuel Power Output

The power measured in the Navy's powder experiments was 1.77 milli-watts per gram. The reduction of reaction rates from a solid fuel to the random alignment obtained in powdered fuel is the statistical reduction of 7.72×10⁻⁶. This means the solid fuel power may be approximately 230 watts per gram of solid fuel.

### Amount of Solid Fuel for a 10 kW Supply

To provide a 10 kW power supply at 230 watts per gram would require 43.5 grams of fuel. If a conversion efficiency of 20-25% is assumed applicable, then some 200 grams of solid fuel would be required.

### Thermal Diodes Required

Given a thermal diode with the specifications: Imax (Amps) 3.0, Qmax (Watts) 28.3, Vmax (Volts) 15.2, DTmax (° C.) 67° C., 2.5 cm square, and 0.5 cm thick. This means that we should be able to get 25 watts from each diode with a volume of 3.125 cm³. Then 10 kW would require 400 diodes, or 2,500 square cm of diode surface.

### Flat Rector Design

By putting a diode on each side of the fuel this would require a 1,250 square cm fuel slab. For fuel density of 0.8 grams/cc 200 grams of fuel would require 250 cc of fuel. This volume would provide the required surface area if it were in a slab only 0.2 cm thick. This is a volume of fuel that is 35 cm×36 cm×0.2 cm or 14 inches×14 inches×0.08 inches thick.

By putting diodes on each side of the fuel we now have a reactor pack 14 inches×14 inches×0.48 inches thick. Alternatively, multiple layers of diodes may be placed on both sides of the fuel to increase the thermal efficiency of the reactor by using the waste heat of the inner diodes in the outer diodes.

In order to establish an operating temperature for the thermal diodes we need of include a cooling system that maintains the temperature of the outside of the thermal diodes at a thermostatically controlled temperature. The cooling system would consist of a cooling jacket around the reactor pack, a liquid pump, a thermostat, and a radiator with a fan to maintain air flow as needed.

On the outside of the diodes we place a liquid cooling jacket that is 0.5 inches thick with channels for liquid flow. The reactor pack is now 15 inches×15 inches×1.48 inches thick.

To provide a source of power for the magnetic control field and to allow for surges in power demand without requiring rapid reactor output changes, we connect the thermal diodes to a battery bank of perhaps 4 large deep cycle 12 volt batteries. The 12 volt DC energy can then be converted into AC power by using one or more standard inverters.

The magnetic control field will consist of wires embedded into the reactor pack to form coils so that the magnetic field through the reactor fuel may be controlled in order to align the field to start the reactor and alter the field to control reactor output level or to shut the reactor down. The magnetic field control will be a digital computer that monitors power demand and reactor conditions and supplies the correct current to the various coils to obtain proper reactor response.

### Physical Size Estimate

The physical sizes of the various parts of the reactor may be expected to be:
1. Reactor pack 15×15×1.5 inches, 337 cubic inches, weight 35 lbs,
2. Coolant pump 4×4×10 inches, 160 cubic inches, weight 5 lbs
3. Radiator 24×24×3 inches, 1,728 cubic inches, weight 10 lbs
4. Battery bank 24×24×10 inches, 5,760 cubic inches, weight 200 lbs
5. Inverters 23×12×9 inches, 2,484 cubic inches, weight 45 lbs
6. Magnetic control module 12×12×9 inches, 1,296 cubic inches, weight 5 lbs.
   These estimates total to an overall size of 99.4 ft³ and 300 lbs. This size is approximately 4 ft×5 ft×5 ft, or slightly larger than a home air conditioner compressor.

### Multiple Thermoelectric Diode Design

The efficiency of the flat design used above is limited to the efficiency of a single TEG. Multiple TEGs may increase the efficiency by using the waste heat from one TEG in more TEGs before the cooling plates. This type of design also reduces the volume and weight of the various reactor designs. The multiple TEG design used in a double stack configuration is shown in FIG. 5.

The multiple TEG, double stack configuration may be further incorporated into an integrated design using almost any desired number of double stacks as shown in FIG. 6.

### Intermediate Scale Reactors

An intermediate scale reactor (0.5 to 5 MW) may be made using this fusion reaction that could power trucks, trains and other mobile users of power. Locomotives have fairly large volumes available for developing the power they need. They also have a well-developed generator, motor final drive system and waste heat removal system. Typically locomotives need high power output levels without the demand for rapid power level changes that is placed on a truck engine. These factors argue that direct steam generation may offer an economic method of carrying the energy away from the reactor for locomotive applications.

The typical manner in which trucks are used places many demands for rapid power level changes upon the engine. Rapid power level changes are not supported easily by steam systems. Over the road trucks might be able to use steam systems to carry the energy from the reactor, but delivery trucks would probably not be a candidate for steam and would rather seem to be best served by the thermoelectric generator system.

### Larger Deuterium Reactors

A large scale reactor such as one for use on a ship or at a major power plant (approximately 10 MW and higher) will likely work best by carrying the energy away through conversion of the heat generated by boiling water or by a pressurized water system. This means that a large scale reactor may be designed in such a way that the fusion reactor simply replaces the fission reactor in current power plant designs. Thus there is no major difference between a large scale fusion power plant and current fission power plants in how the heat is carried away. The real difference lies in the generation of the heat. This difference is a large difference.

The fuel material for the fusion reactor is a crystalline Deuteride that involves no radiation. The reaction, being the preferential fusion of two deuterium nuclei to form a helium nucleus, emits no radiation. The waste product, helium, is non-toxic and emits no radiation. Therefore, no special handling of either the fuel or the waste is necessary, though collecting the helium produced may have advantages. This offers a serious reduction of hazards in the use of a fusion large scale reactor. The reduction of special handling and required shielding offers great reductions cost and size of the large scale fusion reactors.

### Impact of Deuterium Reactors

The development and use of the above series of fusion reactors would significantly impact several sectors of our lives and the Earth's ecology. This impact should be considered before and during any development of these reactors.

### Reduction of Fossil Fuel Use

The potential development of all sizes of the above discussed fusion reactors would make a significant reduction in the demand and use of fossil fuels. For example as fusion takes over the responsibility of providing electric power the use of coal would drop considerably. The use of coal for home heating would also be unnecessary when home fusion reactors begin supplying energy for the individual home.

Fusion automobile power plants coupled with fusion power plants driving trucks, trains and ships would markedly reduce the use of gas and oil. Even the use of natural gas and oil for home heating would not be needed for the home with its own nuclear reactor.

The reduction and virtual elimination of the use of fossil fuels would have a tremendous impact upon the Earth's environment. The pollution currently produced would be almost totally eliminated. The production of green house gases almost stopped.

### Economic Impact

The economic impact of the above series of fusion reactors would be even more striking than the impact upon the reduction of pollution. Perhaps the production, distribution and use of energy involve more political power, money and individual wealth than any other industry or chain of industries. This power and wealth alone may cause the potential of the above series of fusion reactors to become ‘dead on arrival.’

### Economic Impact on Energy Production

The global impact of the transfer of wealth due to oil production and sales is constantly in the news. Countries and individuals owe their wealth and well-being to the money that their oil production brings. Individual and country wealth has followed energy production since the beginning of the industrial revolution set in motion by the control of energy. Those countries and individuals whose wealth is based solely upon the production and sale of oil would see their source of wealth dissipate with the development of the fusion reactors. This short paper cannot, nor intends to try to, do justice to a discussion of the economic impact that the above fusion reactors would have on energy production.

Coal production by the five top coal producing countries exceeds some 5,000 Mt per year. This represents a significant portion of the world's energy production following behind that of the oil industry. This industry would also see a reduction in the demand for its product with the development of fusion reactors.

### Economic Impact on Energy Distribution

Energy distribution is big business. Every home owner or business owner or operator has a utility bill that covers the energy used. Many, if not all, of these distribution companies also produce the electric and gas forms of energy that they distribute. Some may have nuclear and water-driven power plants to generate some of the electric energy they distribute while almost all have oil or coal fired power generation plants. Large scale fusion reactors would eliminate the need for these oil and coal fired power plants.

Industries having large plants that use a lot of energy may install their own large scale reactor and not need to draw their power from a distribution grid. Indeed with homes and industries installing individual reactors the existing large power distribution grids may become a relic of the past. While this might wreck havoc with the distribution companies' income, it would eliminate concern over a power grid failure from either a breakdown or terrorist act.

At first blush it may appear that the utility companies may lose their income should the fusion reactors replace the oil and coal powered plants. However, this may not be mandated by such development. The fusion reactors must be manufactured and maintained. This could be the role of the utility companies. They could manufacture or obtain the reactors and then deliver them to each home through sales or leases and provide for the minimal maintenance they require.

### LEGEND

1. X axis.

2. Y axis.

3. Z axis.

4. Proton.

5. Force.

6. Electron.

7. Voltmeter.

8. Holder.

9. Magnets.

10. Thermo-Electric Generating Diode (TEG).

11. Sample.

12. Magnetic Field.

13. Cooling Plates.

14. Metal Hydride Crystal Fuel.

15. Circuit Board

1. The fusion barrier between two deuterium nuclei may be reduced by placing the nuclei in a crystalline lattice and putting the host crystal in a magnetic field with the field lines parallel to the planes of the deuterium nuclei.
